(19) United States
(12) Patent Application Publication
(10) Pub. No.: US 2023/0076910 A1
(43) Pub. Date: Mar. 9, 2023

(54) VERIFICATION DEVICE, VERIFICATION SYSTEM, AND VERIFICATION METHOD

(71) Applicant: Panasonic Intellectual Property Management Co., Ltd., Osaka (JP)

(72) Inventors: Masao KUBOTA, Tokyo (JP); Yoshinori KUNIEDA, Tokyo (JP); Yutaka YAMAMOTO, Kanagawa (JP)

(73) Assignee: Panasonic Intellectual Property Management Co., Ltd., Osaka (JP)

(21) Appl. No.: 17/800,125

(22) PCT Filed: Feb. 16, 2021
(86) PCT No.: PCT/JP2021/005750

§ 371 Date: Aug. 16, 2022

(30) Foreign Application Priority Data
Feb. 18, 2020 (JP) 2020-025246

(51) Int. Cl. G07C 9/37; G06V 40/16

(52) U.S. Cl. CPC G07C 9/37; G06V 40/172

(57) ABSTRACT

A verification device used in a gate equipped with a restriction unit that restricts a flow of people. The verification device is provided with: a processing unit for performing, in a path in which there is a flow of people from a first area to a second area located upstream of the restriction unit, a second face image verification using a first candidate face image having been narrowed down by the result of first face image verification using a first image in which the first area is imaged and a second image in which the second area is imaged; and a communication unit for outputting the result of the second face image verification.

### TECHNICAL FIELD

The present disclosure relates to a verification apparatus, a verification system, and a verification method.

### BACKGROUND ART

A technique has been known that manages entry and exit of a person passing through a gate installed in a station, an airport, and the like, through face authentication. Patent Literature 1 discloses a technique enabling smooth passing of a person through a gate. The technique of Patent Literature 1 extracts a feature amount of an object in an image taken of an area in front of entrance to the gate, and carries out verification determination on the basis of the verification information registered in advance (information related to a feature amount of a person, and the like) and an estimated distance from a person approaching the gate to the gate. According to the technique of Patent Literature 1, face authentication is carried out after determining if the estimated distance is a distance appropriate for verification.

### CITATION LIST

### Patent Literature

### PTL 1

Japanese Patent Application Laid-Open No. 2019-133364

### SUMMARY OF INVENTION

In light of a short period of time, in the order of several seconds, involved for a person to pass through a gate, a quick process is expected for verification (or authentication) by facial image of the person passing through the gate.

Non-limiting example of the present disclosure facilitates to provision of a verification apparatus, a verification system, and a verification method that enable an increase in processing speed of verification using a facial image of a person passing through a predetermined area such as a gate (hereinafter, may be abbreviated as “facial image verification” or “facial image authentication”).

A verification apparatus according to one example of the present disclosure is an apparatus used in a gate provided with a regulator that regulates a stream of people, the apparatus including: a processor that carries out, in a path with a stream of people from a first area to a second area located upstream of the regulator, second facial image verification by using a first candidate facial image narrowed down by a result of first facial image verification using a first image taken of the first area, and a second image taken of the second area; and a communicator that outputs a result of the second facial image verification.

A verification system according to one example of the present disclosure is a system used in a gate provided with a regulator that regulates a stream of people, the system including: a first camera that takes an image of a first area in a stream of people from the first area to a second area located upstream of the regulator; a second camera that takes an image of the second area; a first verification apparatus that carries out first facial image verification using a first image taken by the first camera; and a second verification apparatus that carries out second facial image verification using a first candidate facial image narrowed down by a result of the first facial image verification and the second image taken by the second camera.

A verification method according to one example of the present disclosure is a method used in a gate provided with a regulator that regulates a stream of people, the method including: carrying out, in a path with a stream of people from a first area to a second area located upstream of the regulator, second facial image verification by using a first candidate facial image narrowed down by a result of first facial image verification using a first image taken of the first area, and a second image taken of the second area; and outputting a result of the second facial image verification.

It should be noted that general or specific embodiments may be implemented as a system, an apparatus, a method, an integrated circuit, a computer program, a storage medium, or any selective combination thereof.

According to one example of the present disclosure, the processing speed of the facial image verification of a person passing through a predetermined area can be increased.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates a configuration example of a face authentication system according to the present disclosure;

FIG. 2 illustrates a hardware configuration example of a face authentication server and a verification apparatus;

FIG. 3 illustrates a functional configuration example of the face authentication server and the verification apparatus;

FIG. 4 illustrates an installation example of a plurality of cameras in a gate;

FIG. 5 illustrates an operation summary of the face authentication system;

FIG. 6 is a flowchart illustrating an operation example of the face authentication system;

FIG. 7 is a flowchart illustrating an operation example in a case in which a mid-distance narrowing down search process fails to verify;

FIG. 8 is a flowchart illustrating an operation example in a case in which a short-distance face authentication process fails;

FIG. 9 illustrates a manner in which a long-distance camera takes an image of people;

FIG. 10 illustrates a manner in which a mid-distance camera takes an image of people;

FIG. 11 illustrates a manner in which a short-distance camera takes an image of a person;

FIG. 12 illustrates a relationship between walking speed of a person passing through the gate and the face authentication process; and

FIG. 13 illustrates a modification of the gate.

### DESCRIPTION OF EMBODIMENTS

Hereinafter, preferred embodiments of the present disclosure will be described in detail with reference to the appended drawings. Note that, in the present specification and drawings, components having substantially the same functions are provided with the same reference symbols, and redundant description will be omitted.

### Embodiment

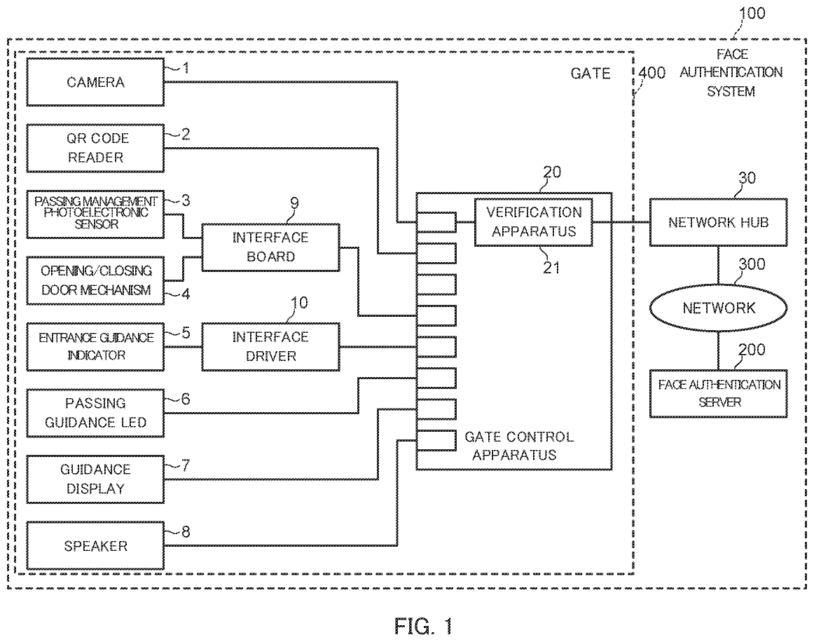

FIG. 1 illustrates a configuration example of the face authentication system according to the present disclosure. Face authentication system 100 according to the present embodiment is a system that controls, for example, a gate (an entrance gate, a ticket gate, and the like) installed in an entrance/exit of a facility such as an airport, a station, an event venue, and the like. Face authentication system 100 according to the present embodiment exemplarily carries out management of entry and exit of users of the facility through face authentication. For example, in a case in which a user enters the facility through the gate, the face authentication determines whether the user is a person allowed to enter the facility or not. In addition, in a case in which a user exits the facility through the gate, the face authentication determines whether the user is a person allowed to exit the facility or not. Note that the “face authentication” may be envisaged as a concept encompassed by “verification using a facial image”.

Face authentication system 100 is provided with gate control apparatus 20 and face authentication server 200. Face authentication system 100 is further provided with a plurality of cameras 1 for taking a facial image, QR code (registered trademark) reader 2, passing management photoelectronic sensor 3, opening/closing door mechanism 4, entrance guidance indicator 5, passing guidance LED (Light Emitting Diode) 6, and guidance display 7. Face authentication system 100 is further provided with speaker 8, interface board 9, interface driver 10, network hub 30, and the like.

Gate control apparatus 20 is connected to network hub 30 and capable of communicating with server 200 via network hub 30 and network 300. Server 200 carries out a process related to the face authentication. Consequently, server 200 may also be referred to as face authentication server 200. Gate control apparatus 20 is an apparatus that controls, for example, a gate (an entrance gate, a ticket gate, and the like) installed in a facility such as an airport, a station, an event venue, and the like. For example, gate control apparatus 20 controls opening/closing door mechanism 4 of the gate. For example, the gate is opened for a person allowed by the face authentication. On the other hand, the gate is closed for a person whose face authentication failed.

The face authentication uses, for example, information of facial images of several hundreds of thousands to several tens of millions of people. The information is recorded in, for example, face authentication server 200. Hereafter, the information used for the face authentication may be referred to as “authentication information” or “verification information”. For example, the authentication information may be recorded in face authentication server 200 in advance through a registration procedure of a user using the face authentication service.

Verification apparatus 21 is communicatively connected to face authentication server 200 via network 300. Verification apparatus 21 verifies a facial image of a person passing through the gate against facial images of a population included in the registered authentication information to authenticate the person passing through the gate.

The expression “verification” means determination of whether the facial image of the person passing through the gate matches any of the facial images registered in advance or not, or whether the facial image of the person passing through the gate and any of the facial images registered in advance are facial images of the same person or not, through comparison of the facial image of the person passing through the gate against the facial images registered in advance.

On the other hand, “authentication” means proving that the person of the facial image matching any of the facial images registered in advance is the person him/herself (in other words, a person allowed to pass through the gate) to an external section (for example, the gate).

However, in the present disclosure, “verification” and “authentication” may be used as mutually interchangeable terms.

For example, the verification process is a process that identifies who a face in image data is through comparison between a feature point in the facial image of each individual registered in advance and a feature point extracted from the facial image detected by a face detection process. Gate control apparatus 20 controls the gate (for example, open/close behavior of opening/closing door mechanism 4) according to a result of the authentication. Note that verification apparatus 21 is only required to be provided in a communicative manner with face authentication server 200, and may be either embedded in gate control apparatus 20 or provided outside gate control apparatus 20.

QR code reader 2 reads a QR code including information for identifying the person passing through the gate. For example, among the people passing through the gate, a person subjected to the entry/exit management without using the face authentication lets QR code reader 2 read the QR code to get authenticated.

Passing management photoelectronic sensor 3 detects whether a person has entered the gate or not, and whether the person allowed to pass through the gate has passed through the gate or not. For example, passing management photoelectronic sensor 3 may be provided in a plurality of positions including a position where the detection of whether a person has entered the gate or not is carried out, and a position where the detection of whether the person has passed through the gate or not is carried out. Passing management photoelectronic sensor 3 is connected to gate control apparatus 20 via, for example, interface board 9. Note that the method of detection of entry and passing of a person is not limited to the method using the photoelectronic sensor, and may also be realized by another method such as monitoring of behavior of a person captured by a camera installed on a ceiling and the like. In other words, the photoelectronic sensor is an example of the sensor for passing management, and other sensors may be used.

Opening/closing door mechanism 4 is connected to gate control apparatus 20 via, for example, interface board 9.

Entrance guidance indicator 5 notifies whether passing of gate 400 has been permitted or not. Entrance guidance indicator 5 is connected to gate control apparatus 20 via, for example, interface driver 10.

Passing guidance LED 6 emits light of a color corresponding to a state of gate 400 to notify whether gate 400 is in a passable state or not.

Guidance display 7 displays, for example, information related to permission or prohibition of passing.

Speaker 8 produces, for example, sound indicating permission or prohibition of passing.

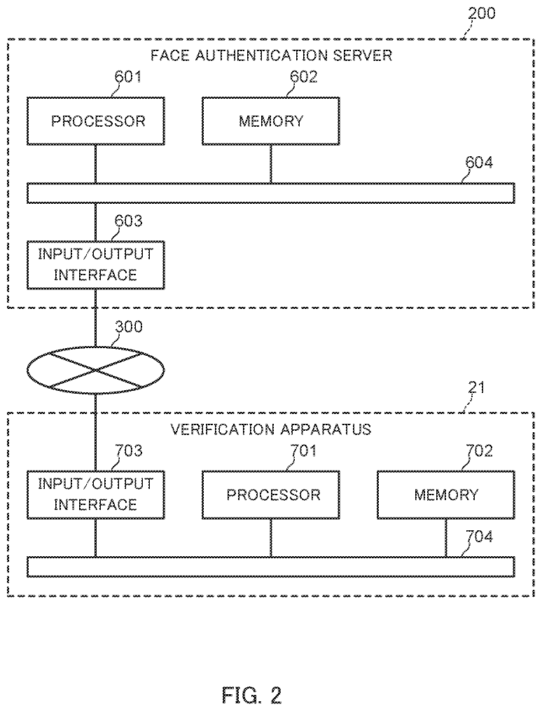

Next, hardware configurations of face authentication server 200 and verification apparatus 21 are described with reference to FIG. 2. FIG. 2 illustrates a hardware configuration example of face authentication server 200 and verification apparatus 21.

Face authentication server 200 is provided with processor 601, memory 602, and input/output interface 603 used for transmission of various information. Processor 601 is a computing apparatus such as a CPU (Central Processing Unit), a GPU (Graphics Processing Unit), and the like. Memory 602 is a storage device realized by using RAM (Random Access Memory), ROM (Read Only Memory), and the like. Processor 601, memory 602 and input/output interface 603 are connected to bus 604 and delivers various information via bus 604. Processor 601 retrieves a program, data, and the like stored in the ROM onto the RAM and executes a process, whereby the function of face authentication server 200 is realized.

Verification apparatus 21 is provided with processor 701, memory 702, and input/output interface 703 used for transmission of various information. Processor 701 is a computing apparatus such as a CPU, a GPU, and the like. Memory 702 is a storage device realized by using RAM, ROM, and the like. Processor 701, memory 702 and input/output interface 703 are connected to bus 704 and delivers various information via bus 704. Processor 701 retrieves a program, data, and the like stored in the ROM onto the RAM and executes a process, whereby the function of verification apparatus 21 is realized.

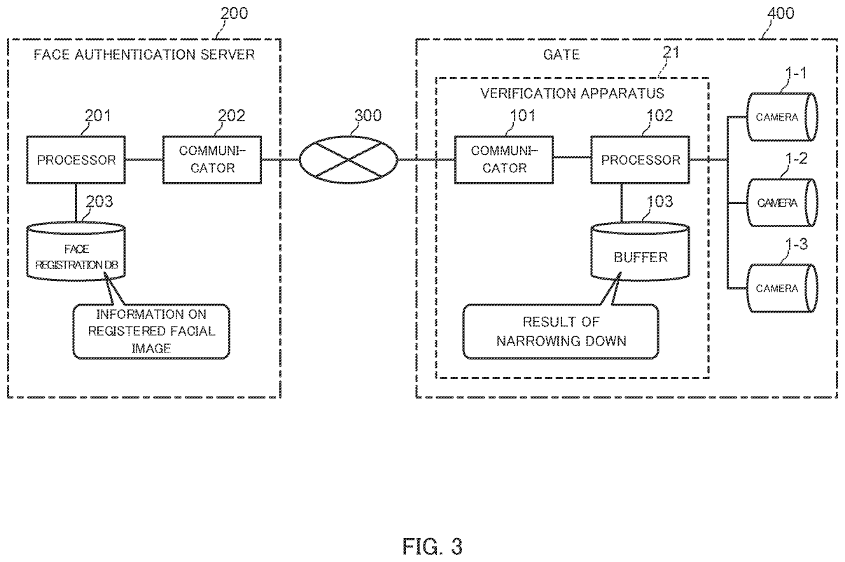

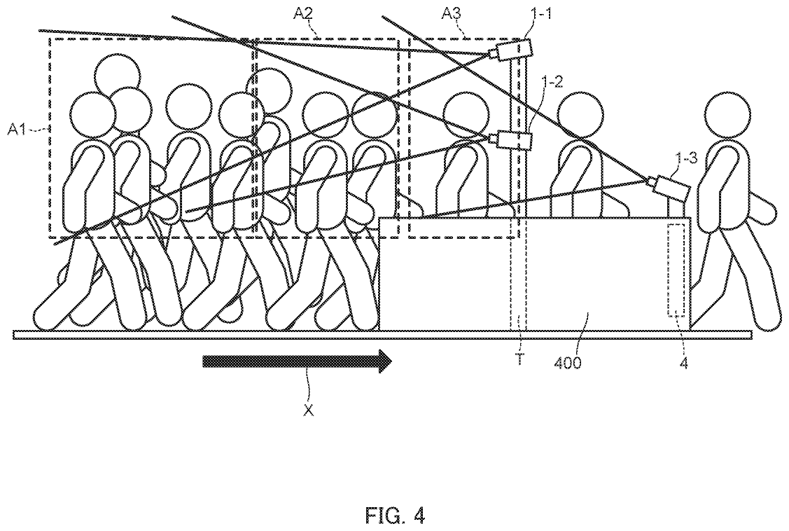

Next, functions of face authentication server 200 and verification apparatus 21 are described with reference to FIG. 3, and then a disposing example of camera 1 is described with reference to FIG. 4. FIG. 3 illustrates a functional configuration example of face authentication server 200 and verification apparatus 21. FIG. 4 illustrates an installation example of a plurality of cameras 1 in the gate.

Gate 400 is provided with, for example, three cameras 1 (camera 1-1, camera 1-2, and camera 1-3).

Three cameras 1 each take an image of a person moving toward gate 400 in a traveling direction of arrow X in FIG. 4. In FIG. 4, arrow X indicates the traveling direction of a person in a path with a stream of people from area A1 (first area) to area A3 (second area) via area A2 (third area). Note that at least a part of gate 400 is disposed in area A3. In addition, two lines extending from camera 1 exemplarily show an image-taking range of camera 1.

Camera 1-1 takes an image of the face of a person present in area A1 in a position away from gate 400 by a predetermined distance. Area A1 is provided upstream of gate 400 in traveling direction X. Area A1 is, for example, an area from a position 1.5 m away from supporter T that supports camera 1-1 and camera 1-2 of gate 400, to a position 3.0 m away from supporter T. Camera 1-1 takes an image of the face of a person present in area A1 relatively away from gate 400. Hereafter, camera 1-1 may be referred to as a “long-distance camera”. An image taken by camera 1-1 is input to processor 102.

Camera 1-3 is the second camera that takes an image of the face of a person present in area A3 closer to gate 400 than area A1. Area A3 is, for example, an area from supporter T to a position 50 cm away therefrom in an opposite direction to traveling direction X of the person. Hereafter, camera 1-3 may be referred to as a “short-distance camera”.

Camera 1-2 is the third camera that takes an image of the face of a person present in area A2 between area A1 and area A3. Area A2 is, for example, an area from a position 1.5 m away from supporter T to a position 50 cm away from supporter T. Hereafter, camera 1-2 may be referred to as a “mid-distance camera”.

Note that the image-taking range of camera 1 is not limited to the above-described example. For example, at least a part of the image-taking range of each camera 1 may overlap one another. For example, an area captured by camera 1-3, which is the short-distance camera, is not limited to a range of area A3, and may be a range including area A3 and the entirety or a part of area A2. In addition, although FIG. 4 illustrates an example in which the image-taking ranges of respective cameras 1 are adjacent to each other in the traveling direction (arrow X), a gap may be present between the image-taking ranges of respective cameras 1.

However, area A3, which is an area for authentication of a person about to pass through gate 400, may be an area downstream in traveling direction X of a position where entry of a person into gate 400 is determined. For example, in a case in which gate 400 determines whether a person has entered or not with passing management photoelectronic sensor 3, area A3 is downstream of a position in which passing management photoelectronic sensor 3 detects entry of a person.

In addition, the image-taking range of camera 1 exemplarily shown in FIG. 4 is merely a conceptual representation of a range of the focal length, the angle of view, and the like, with which each camera 1 can take an image clear enough to carry out face verification, and is not intended to exclude capture of an image matching a region outside of the area.

Note that the installation positions of cameras 1 are not limited to those in the above-described example. For example, the long-distance camera (camera 1-1) may be provided away from gate 400, instead of being attached to gate 400, and take an image of area A1. In addition, for example, the mid-distance camera (camera 1-2) may be provided away from gate 400, instead of being attached to gate 400, and take an image of area A2. Furthermore, for example, the short-distance camera (camera 1-3) may be provided away from gate 400, instead of being attached to gate 400, and take an image of area A3.

Instead of an image taken by camera 1 attached to gate 400, face authentication server 200 and verification apparatus 21 may also use, for example, an image taken by a camera for other usage such as a surveillance camera and the like.

For example, an imaging frame rate, the number of images to be taken (number of facial images to be recorded), the maximum number of faces to be detected, and the like of these cameras are configured according to the type of gate 400, the installation positions of the cameras, and the like.

Verification apparatus 21 is provided with communicator 101 that communicates with face authentication server 200 via network 300, buffer 103 that temporarily records various information, and processor 102. Processor 102 carries out processes such as face authentication, face verification, and the like of a person who may pass through gate 400.

Face authentication server 200 is provided with communicator 202 that communicates with verification apparatus 21 via network 300, face registration database (DB) 203 that manages authentication information, and processor 201. The authentication information includes, for example, information of facial images of several hundreds of thousands to several tens of millions of users.

Next, an operation summary and detailed operation of face authentication server 200 and verification apparatus 21 are described.

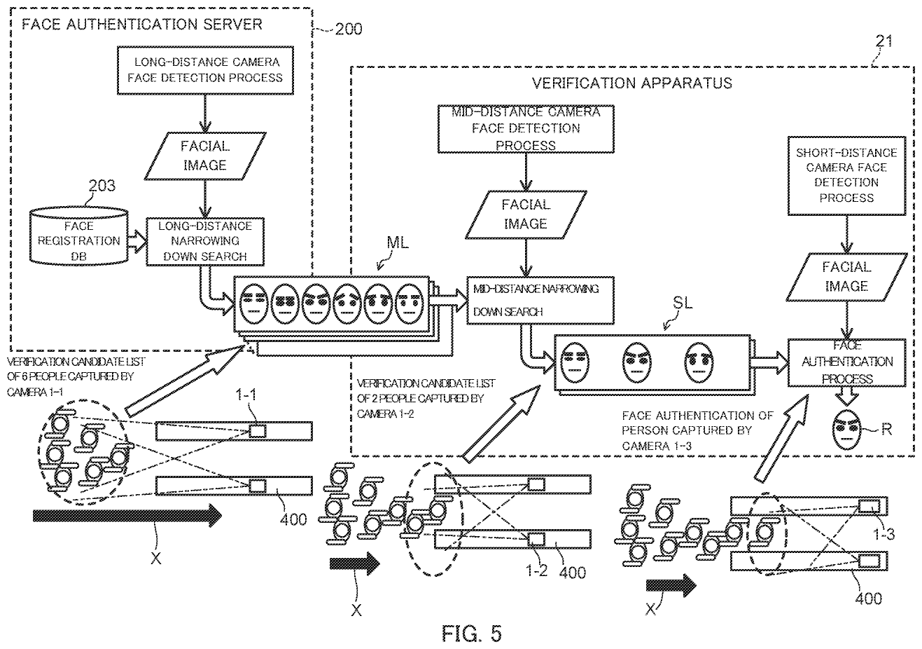

FIG. 5 illustrates the operation summary of face authentication system 100. Face authentication server 200 detects a region of a human face (facial image) from the image taken by the long-distance camera, and verifies the detected facial image against facial images included in face registration DB 203 to narrow down verification candidates from the facial images included in face registration DB 203. Hereafter, a process of narrowing down the verification candidates using the image taken by the long-distance camera may be referred to as “long-distance narrowing down search”. In FIG. 5, the long-distance narrowing down search corresponds to the first narrowing down search (primary narrowing down search).

For example, face authentication server 200 calculates a score indicating similarity of two facial images between the two facial images, and narrows down the verification candidates on the basis of the calculated score. The similarity of two facial images represents probability of the two facial images being facial images of the same person. The higher score exemplarily indicates higher probability of the two facial images being facial images of the same person.

For example, face authentication server 200 calculates, for each of the facial images included in face registration DB 203, the score between the facial image detected from the image taken by the long-distance camera and the facial image included in face registration DB 203. And then, face authentication server 200 buffers N₁ facial images (N₁ being an integer of 1 or greater) in a descending order of the score, to verification candidate list ML. For example, FIG. 5 illustrates an example in which N₁=6. Note that the process of detecting the human facial image from the image taken by the long-distance camera may be carried out by verification apparatus 21.

As a result of the long-distance narrowing down search, verification candidate list ML includes, for example, facial images (candidate facial images) narrowed down from the facial images in face registration DB 203. For example, in FIG. 5, six candidate facial images are included for respective facial images of six people taken by the long-distance camera. And then, face authentication server 200 transmits verification candidate list ML to verification apparatus 21. Verification candidate list ML is transmitted to verification apparatus 21. Verification candidate list ML is an example of the verification candidates narrowed down by using the facial images taken by the long-distance camera.

Verification apparatus 21 detects a human facial image from the image taken by the mid-distance camera, and verifies the detected facial image against facial images included in verification candidate list ML to narrow down the verification candidates from facial images included in verification candidate list ML. Hereafter, a process of narrowing down the verification candidates using the image taken by the mid-distance camera may be referred to as “mid-distance narrowing down search”. In FIG. 5, the mid-distance narrowing down search corresponds to the second narrowing down search (secondary narrowing down search).

For example, verification apparatus 21 calculates, for each of the facial images included in verification candidate list ML, the score between the facial image detected from the image taken by the mid-distance camera and the facial image included in verification candidate list ML. And then, verification apparatus 21 buffers N₂ candidate facial images (N₂ being an integer of 1 or greater) in a descending order of the score, to verification candidate list SL. For example, FIG. 5 illustrates an example in which N₂=2. Note that N₂ may be smaller than N₁.

As a result of the mid-distance narrowing down search, verification apparatus 21 obtains N₂ candidate facial images, which are the verification candidates, from verification candidate list ML and buffers them to verification candidate list SL. In the example of FIG. 5, verification candidate list SL includes, for example, three candidate facial images for each of the facial images of two people taken by the mid-distance camera. Note that, when the narrowing down search is not possible, verification apparatus 21 may request face authentication server 200 to carry out the narrowing down search.

Next, verification apparatus 21 carries out the face authentication process through verification of the facial image corresponding to the face captured by the short-distance camera against verification candidate list SL. When the face authentication fails, verification apparatus 21 requests face authentication server 200 to carry out the narrowing down search.

As described above, face authentication system 100 carries out narrowing down of the verification candidates before a person enters gate 400. By narrowing down the verification candidates before a person enters gate 400, the face authentication process performed upon entry of the person to gate 400 is carried out in a state in which the verification candidates have been narrowed down, whereby speeding-up of the face authentication process is enabled.

Note that, in FIG. 5, verification candidate list ML may include results of the long-distance narrowing down search carried out for a plurality of times. For example, results of the long-distance narrowing down search carried out for each of the images taken by the long-distance camera at a plurality of points of time may be included in verification candidate list ML.

Note that, in FIG. 5, verification candidate list SL may include results of the mid-distance narrowing down search carried out for a plurality of times. For example, results of the long-distance narrowing down search carried out for each of the images taken by the mid-distance camera at a plurality of points of time may be included in verification candidate list SL.

Information included in verification candidate list ML and verification candidate list SL (for example, facial image) may be deleted after a lapse of predetermined time after addition of the information to the list. Alternatively, the condition for deleting the information from the list may be detection of completion of passing of the person corresponding to the information through the gate by passing management photoelectronic sensor 3 and the like. In a case in which gate 400 manages entry and exit to/from a closed space (building, public transport, and the like), the information may be deleted upon detection of exit of the person corresponding to the information from the closed space.

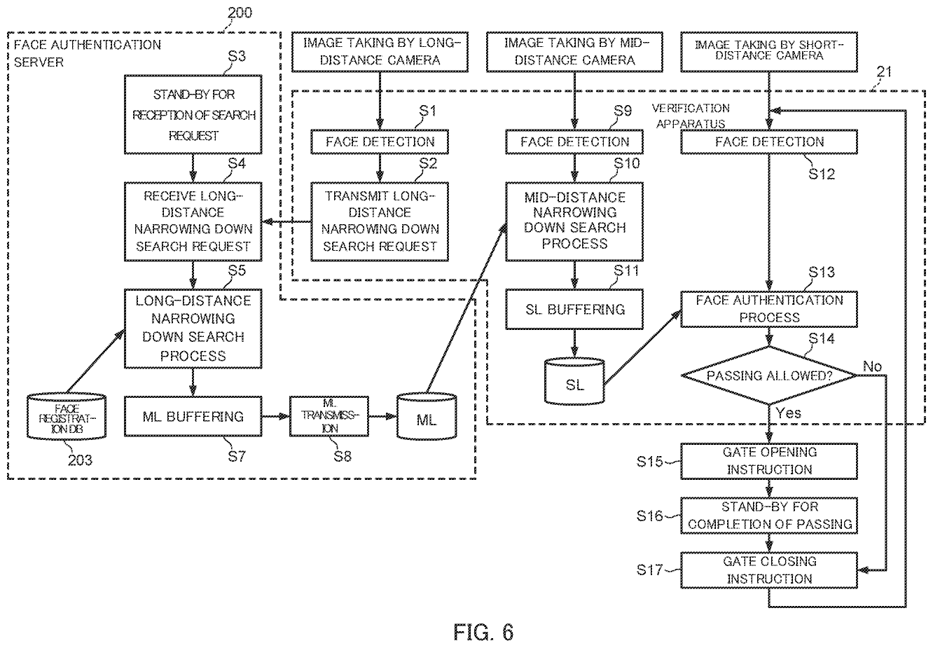

FIG. 6 is a flowchart illustrating an operation example of face authentication system 100. Verification apparatus 21 carries out detection of a face from the image taken by the long-distance camera (Step S1). Verification apparatus 21 transmits a request of the long-distance narrowing down search to face authentication server 200 (Step S2). Upon request of the long-distance narrowing down search, for example, verification apparatus 21 transmits the facial image detected from the image taken by the long-distance camera to face authentication server 200. Note that verification apparatus 21 may either transmit data of the facial image, or extract data related to a feature point used in the search from the data of the facial image and then transmit the extracted data. In the case of transmitting the data of the facial image, the face verification may be carried out by an arbitrary verification method since face authentication server 200 can process the data of the facial image. On the other hand, in the case of extracting and transmitting the data related to the feature point, the volume of data to be transmitted may be reduced.

In Step S3, processor 201 of face authentication server 200 standing by for reception of a search request receives the request (Step S4), and carries out the long-distance narrowing down search (Step S5). Processor 201 buffers the candidate facial images narrowed down by the long-distance narrowing down search to verification candidate list ML (Step S7). Processor 201 transmits verification candidate list ML to verification apparatus 21 (Step S8).

Verification apparatus 21 carries out detection of a facial image from the image taken by the mid-distance camera (Step S9). Verification apparatus 21 verifies the facial image detected from the image taken by the mid-distance camera against the candidate facial images in verification candidate list ML to carry out the mid-distance narrowing down search (Step S10). Verification apparatus 21 buffers the candidate facial images narrowed down from verification candidate list ML to verification candidate list SL (Step S11).

Verification apparatus 21 carries out detection of a facial image from the image taken by the short-distance camera (Step S12). Verification apparatus 21 verifies the facial image detected from the image taken by the short-distance camera against the candidate facial images in verification candidate list SL to carry out the face authentication process (Step S13).

Specifically, verification apparatus 21 verifies the facial image detected from the image taken by the short-distance camera against the candidate facial images in verification candidate list SL. As a result of the verification, in a case in which the facial image detected from the image taken by the short-distance camera matches any one of the facial images in verification candidate list SL, verification apparatus 21 determines that the person captured by the short-distance camera is allowed to pass through gate 400.

As a result of the verification, in a case in which the facial image detected from the image taken by the short-distance camera does not match the facial images in verification candidate list SL, verification apparatus 21 determines that the person captured by the short-distance camera is not allowed to pass through gate 400.

For example, in a case in which one of the scores calculated from the facial image detected from the image taken by the short-distance camera and the facial image in verification candidate list SL is greater than or equal to a threshold value, verification apparatus 21 determines that the facial image in verification candidate list SL corresponding to the score greater than or equal to the threshold value matches the facial image detected from the image taken by the short-distance camera.

Note that, in a case in which the score calculated from the facial image detected from the image taken by the short-distance camera and the facial image in verification candidate list SL is less than the threshold value, verification apparatus 21 may determine that the facial image detected from the image taken by the short-distance camera does not match the facial image in verification candidate list SL. In a case in which there is a plurality of facial images indicating scores greater than or equal to the threshold value, verification apparatus 21 may determine that the facial image detected from the image taken by the short-distance camera does not match the facial image in verification candidate list SL. By thus determining that the face verification fails in the case of impossibility of narrowing down to one person, a strict determination result can be obtained.

Alternatively, in a case in which there is a plurality of facial images indicating scores greater than or equal to the threshold value, the facial image detected from the image taken by the short-distance camera may be determined to match any of the facial images in verification candidate list SL. As such, blockage of the stream of people can be prevented even in the case of face verification of a person with whom narrowing down to one person is difficult, such as a twin. Note that, even in this case, the score greater than or equal to the threshold value has been obtained, assuring a certain level of validity. Consequently, the face verification would never be successful for a person who is obviously not the verification candidate (for example, a person of a facial image not registered in face registration DB 203).

In a case in which the face authentication in S13 has been successful and the person captured by the short-distance camera is allowed to pass through gate 400 (Step S14, Yes), verification apparatus 21 generates result information R indicating that the person is allowed to pass. And then, gate control apparatus 20 issues a gate open instruction on the basis of result information R (Step S15), and the gate is maintained in the open state until the person has passed through gate 400 in Step S16. After the person has passed through gate 400, a gate close instruction is issued (Step S17), and the process of Steps S12 and later is repeated.

In a case in which the person captured by the short-distance camera is not allowed to pass through gate 400 (Step S14, No), verification apparatus 21 generates result information R indicating that the person is not allowed to pass. And then, gate control apparatus 20 carries out the processing of Step S17 on the basis of result information R.

FIG. 6 illustrates an example in which verification apparatus 21 can create verification candidate list SL through the mid-distance narrowing down search; however, verification apparatus 21 may not be able to create verification candidate list SL due to an inappropriate result of the mid-distance narrowing down search process. The case of an inappropriate result of the mid-distance narrowing down search process includes, for example, a case in which each of the scores between the facial image detected from the image captured by the mid-distance camera and the respective candidate facial images in verification candidate list ML are less than the threshold value. The case of an inappropriate result of the mid-distance narrowing down search process occurs, for example, when a facial image of a person not included in the image taken by the long-distance camera is included in the image taken by the mid-distance camera.

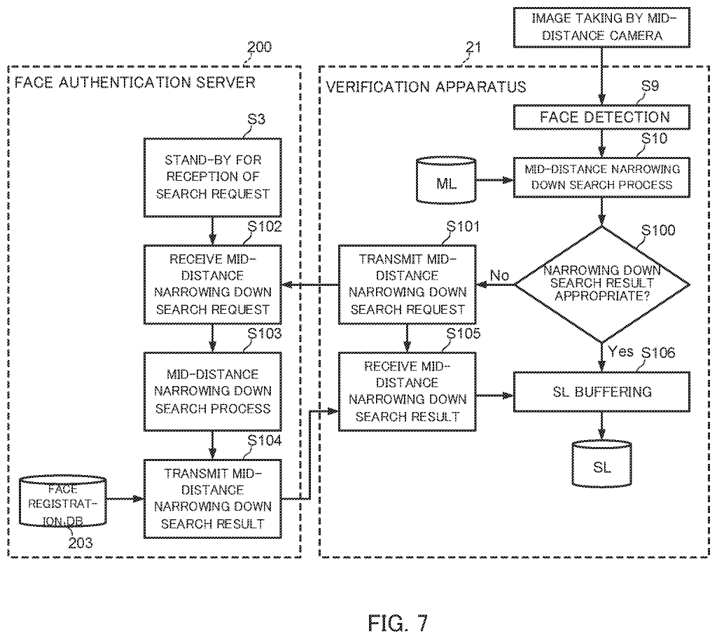

FIG. 7 is a flowchart illustrating an operation example in a case in which the result of the mid-distance narrowing down search process is inappropriate. Hereafter, description is omitted for the processes identical to the processes of each of the step numbers shown in FIG. 6, and different processes are described.

In a case in which the result of the mid-distance narrowing down search process is inappropriate (Step S100, No), verification apparatus 21 transmits a request of the mid-distance narrowing down search to face authentication server 200 (Step S101). Here, verification apparatus 21 may transmit the facial image detected from the image taken by the mid-distance camera to face authentication server 200.

Upon reception of the request of the mid-distance narrowing down search (Step S102), face authentication server 200 carries out the mid-distance narrowing down search process (Step S103), and transmits the result of the mid-distance narrowing down search process to verification apparatus 21 (Step S104). In the mid-distance narrowing down search process in Step S103, face authentication server 200 verifies the facial image detected from the image taken by the mid-distance camera against the candidate facial images included in face registration DB 203.

Upon reception of the result of the mid-distance narrowing down search process (Step S105), verification apparatus 21 buffers the result to verification candidate list SL (Step S106).

In a case in which the mid-distance narrowing down search process has been successful (Step S100, Yes), the process of Step S106 is carried out.

According to the flow chart of FIG. 7, even in the case in which verification apparatus 21 is not able to create verification candidate list SL due to the inappropriate result of the mid-distance narrowing down search process (for example, in the case of No in S100 in FIG. 7), the face authentication process (see FIG. 6) can be carried out by requesting face authentication server 200 to re-search.

Note that verification apparatus 21 may also request face authentication server 200 to re-search, in the case in which the face authentication process has failed and passing is not allowed in the passing determination of S14 in FIG. 6. For example, verification apparatus 21 may request face authentication server 200 to re-search in a case in which each of the scores between the facial image detected from the image captured by the short-distance camera and the respective candidate facial images in verification candidate list SL are less than the threshold value. For example, verification apparatus 21 may request face authentication server 200 to re-search in a case in which a person not included in the image taken by the mid-distance camera is included in the image taken by the short-distance camera. Note that, when verification apparatus 21 requests face authentication server 200 to re-search, the verification in verification apparatus 21 may be delayed by a time period required for communication for obtaining the verification candidate list again from face authentication server 200. However, in view of low probability of occurrence of the request of re-search, the processing speed of verification apparatus 21 is increased compared to the case of not carrying out narrowing down at all, even if such a process is involved.

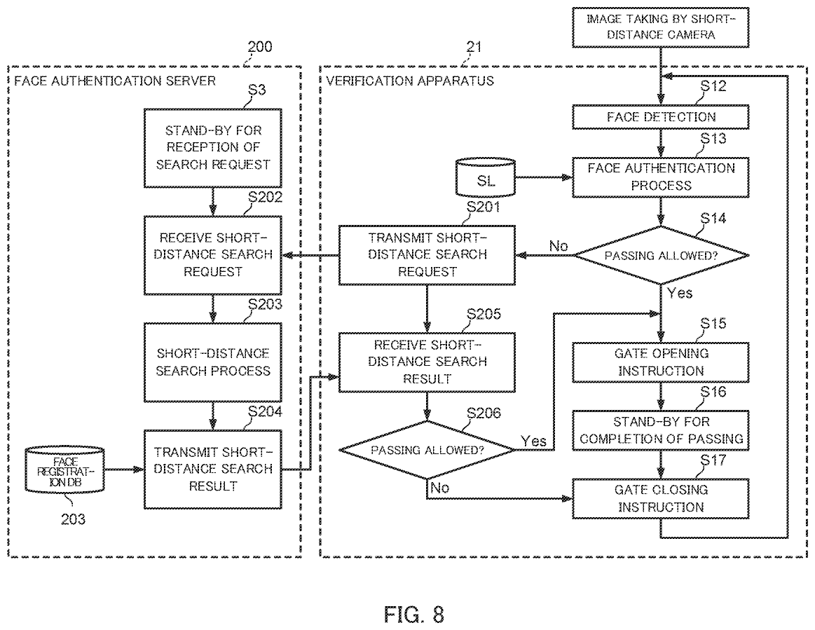

FIG. 8 is a flowchart illustrating an operation example in the case of a failure in the face authentication process. Hereafter, description is omitted for the processes identical to the processes of the step numbers shown in FIG. 6, and different processes are described.

In a case in which the person captured by the short-distance camera is not allowed to pass through gate 400 (Step S14, No), verification apparatus 21 transmits a request of the short-distance search to face authentication server 200 (Step S201). Verification apparatus 21 may transmit the facial image detected from the image taken by the short-distance camera to face authentication server 200.

Face authentication server 200 receives the request of the short-distance search (Step S202) and carries out the short-distance search process (Step S203). For example, face authentication server 200 verifies the facial image detected from the image taken by the mid-distance camera against the candidate facial images included in face registration DB 203. Face authentication server 200 identifies, for example, one person matching the highest-score candidate facial image through the verification, and transmits a processing result including information of the single identified person to verification apparatus 21 (Step S204). In the short-distance face narrowing down search process in Step S203, face authentication server 200 verifies the facial image detected from the image taken by the short-distance camera against the facial images included in face registration DB 203.

Upon reception of a result of the short-distance face narrowing down search process (Step S205), verification apparatus 21 verifies the facial image detected from the image taken by the short-distance camera against the result to carry out the face authentication process similar to the process of Step S13 and determines eligibility for passing (Step S206) as in Step S14.

As a result, in the case in which the person captured by the short-distance camera is allowed to pass through gate 400 (Step S206, Yes), verification apparatus 21 generates result information R indicating that the person is allowed to pass. Consequently, the processes of Steps S15 and later are carried out.

As a result of the verification, in a case in which the person captured by the short-distance camera is not allowed to pass through gate 400 (Step S206, No), verification apparatus 21 generates result information R indicating that the person is not allowed to pass. The gate doors thus do not open (Step S17).

Note that FIG. 8 illustrates an example in which, in a case in which the person captured by the short-distance camera is not allowed to pass through gate 400 (Step S14, No), verification apparatus 21 transmits the request of the short-distance search to face authentication server 200; however, the present disclosure is not limited thereto. For example, instead of transmitting the request of the short-distance search to face authentication server 200, verification apparatus 21 may verify the facial image detected from the image taken by the short-distance camera against the candidate facial images in verification candidate list ML. Since verification candidate list ML is buffered to verification apparatus 21, verification to an extent of the candidate facial images included in verification candidate list ML may be carried out without communicating with face authentication server 200. Therefore, if the verification to an extent of the candidate facial images included in verification candidate list ML is successful, the verification process can be sped up by omitting communication. However, since verification candidate list ML is a relatively large list, depending on the communication rate of verification apparatus 21 and network 300, the process may be completed earlier by transmitting the request of the short-distance search to face authentication server 200. Consequently, if the size of verification candidate list ML is variable, it may be possible to switch between transmission of the request of the short-distance search and verification with the candidate facial images included in verification candidate list ML according to the size.

In FIG. 8, information sent back by face authentication server 200 in response to the request of the short-distance search is a result of the short-distance face narrowing down search process, and verification apparatus 21 carries out the verification process with the result (Steps S205, S206). However, if the processing performance of face authentication server 20 is high enough, face authentication server 200 may make a decision on success or failure of the face verification and transmit the decision as is. In this case, verification apparatus 21 determines eligibility for passing on the basis of the received result of success or failure of the face verification, and carries out a gate open/close process.

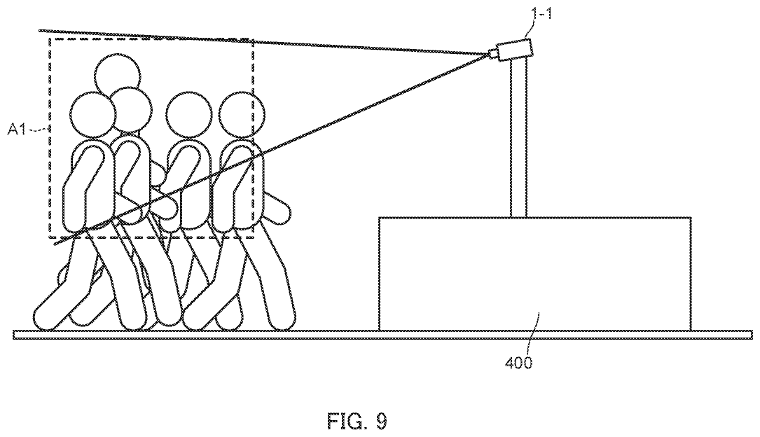

FIG. 9 illustrates a manner in which the long-distance camera takes an image of people. The long-distance camera (camera 1-1) is capable of taking an image of the face of a person present in area A1 in a position away from gate 400 by a predetermined distance. Consequently, the registered verification information with a large population can be roughly narrowed down to a plurality of people who may pass through gate 400, by using the facial images of a plurality of people who may pass through gate 400. By thus carrying out the narrowing down in advance by using the facial images taken by the long-distance camera, the face authentication process carried out upon entry of a person to gate 400 can be sped up.

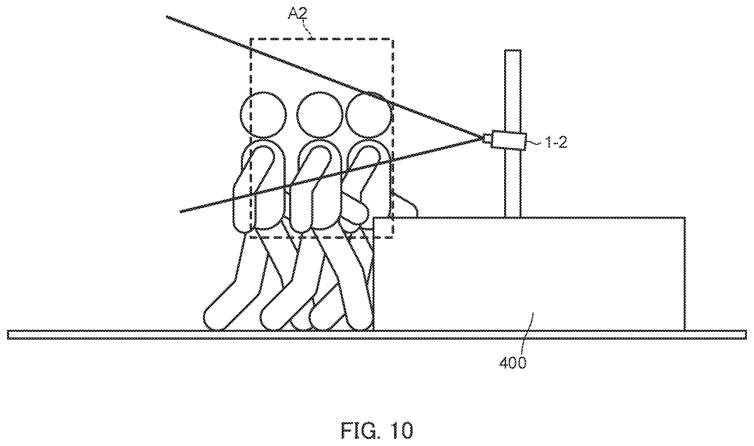

FIG. 10 illustrates a manner in which a mid-distance camera takes an image of people. The mid-distance camera (camera 1-2) is capable of taking an image of the face of a person present in area A2 closer to gate 400 than area A1. Consequently, verification candidate list ML can be narrowed down to one or a plurality of people more likely to pass through gate 400, for example, immediately before the person enters gate 400. By this narrowing down, the face authentication process carried out upon entry of a person to gate 400 can be further sped up. In addition, even in a case in which there is a person that the long-distance camera cannot capture, verification using the mid-distance camera is enabled by carrying out the process illustrated in FIG. 7. The person that the long-distance camera cannot capture is, for example, a person who intrudes into gate 400, a person who enters gate 400 following close behind a previous passenger, and the like.

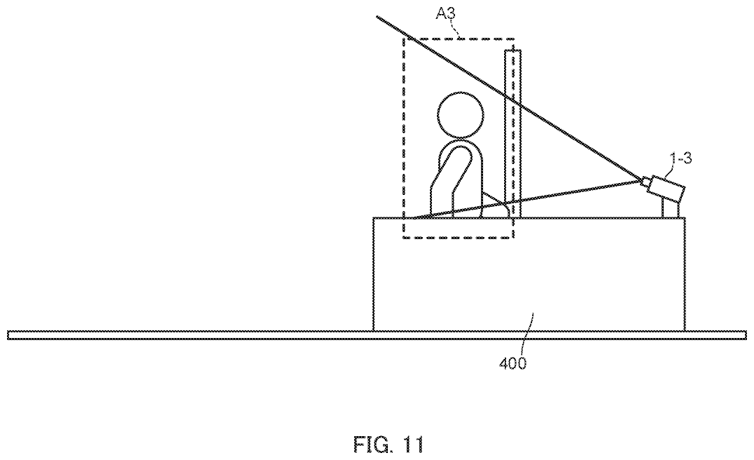

FIG. 11 illustrates a manner in which the short-distance camera takes an image of a person. The short-distance camera (camera 1-3) is capable of taking a clear facial image of a person passing through gate 400, thus enabling the face authentication process with high accuracy. In addition, since verification targets have been narrowed down in advance, high-speed verification is enabled, leading to possibility of verification of a relatively fast-walking person. Furthermore, since the load of the face authentication process is alleviated compared to the case of carrying out the face authentication process on a large population, an inexpensive CPU with lower processing performance may be employed. With alleviation of the load of the face authentication process, the resolution of the short-distance camera can be improved accordingly, enabling further improvement of authentication accuracy.

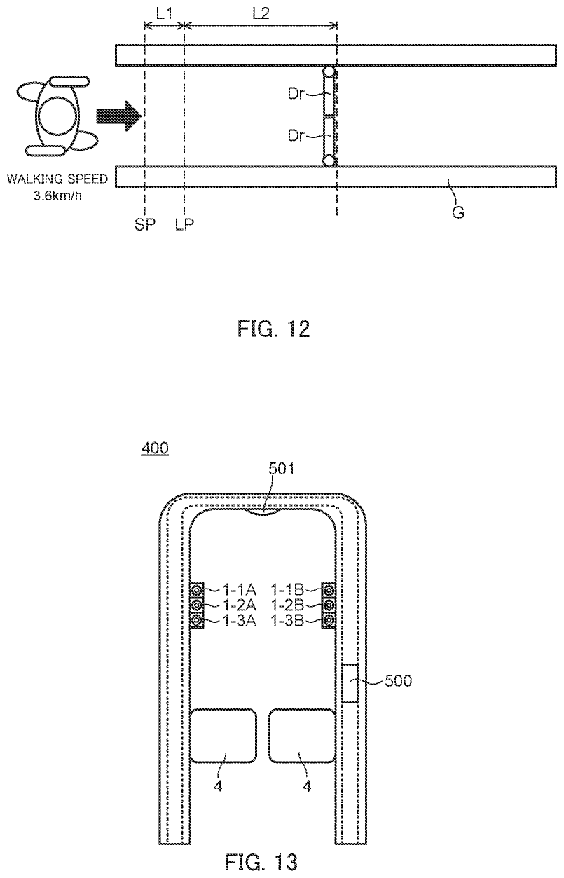

FIG. 12 illustrates a relationship between walking speed of a person passing through gate G and the face authentication process. In the case of the gate in which the face authentication determines eligibility of passing, the length of the gate is defined on the basis of a relationship between the face authentication processing time and a time period between emission of a gate open command from opening/closing door mechanism Dr and completion of opening of the gate (performance). The relationship is described hereafter.

Position SP in FIG. 12 indicates a position where the face authentication process of a person passing through gate G is started. In order to prevent the face authentication process from allowing to pass through the gate with a face of a person who has not entered gate G, this position is desirably located where a person is found after entering gate G. For example, in the case of gate 400 as described above, passing management photoelectronic sensor 3 corresponds to the position where entry to gate 400 is detected. Position LP indicates a position of a boundary for emitting a command for opening and closing gate G. In the case of gate G provided with physical opening/closing door mechanism Dr, opening and closing behavior takes a predetermined period of time to complete. The period of time (gate open processing time) is difficult to largely reduce from the viewpoint of technical performance and safety. Consequently, length L2, which reflects the human walking speed considered to be typical in the period of time, is the shortest length of gate G in the case in which a time period required for determination of opening and closing is assumed to be zero. On the other hand, with the configuration of determining opening or closing of opening/closing door mechanism 4 according to the result of the face authentication process as in the present embodiment, the face authentication process must be completed by the moment where a person reaches position LP, at the latest. Consequently, the length from opening/closing door mechanism Dr of gate G to position SP where the face authentication process of a person passing through gate G is started is obtained by adding length L1 reflecting the time period required for the face authentication process (face authentication processing time) to length L2.

As a specific example, in a case in which the walking speed is 3.6 km/h, the face authentication processing time is 200 msec, and the gate open processing time is 600 msec, the distance between a gate end (gate entrance) to opening/closing door mechanism Dr may be defined to be 800 mm or greater. Since it is difficult to reduce length L2 as described above, reduction of the gate length requires reduction of length L1, in other words reduction of the time period required for the face authentication process.

In addition, when the number of registered people reaches a million to ten million, the face verification may be delayed. For example, with the false acceptance rate (FAR) being 0.001%, a wrong person may be a candidate at a rate of one in a hundred thousand. Even with the FAR being 0.0001%, a wrong person may be a candidate at a rate of one in a million. In order to reduce the FAR, a more complex face verification process such as evaluations from various viewpoints is required, leading to tendency of the longer processing time of the face verification.

In a case of gate 400 with a narrow passage not allowing two or more people to pass at the same time, such as a ticket gate, a person rejected to pass cannot readily step back if there is a queue behind. Consequently, it is ideal that the authentication is completed upon entry of a person to gate 400.

As such, speeding-up of the face verification is required for any of the objectives: reducing the size of the gate; reducing the FAR; and ensuring convenience in a narrow passage.

Verification apparatus 21 according to the present disclosure is capable of, with the facial image of a person approaching gate 400 captured by using the long-distance camera, carrying out the narrowing down search in the verification information with a large population by using the facial image before the person enters gate 400. The face verification process using the short-distance camera can thus be sped up.

FIG. 13 illustrates a modification of the gate. Gate 400 in an arc-like shape illustrated in FIG. 13 includes reader 500 that reads a code such as a QR code including information for identifying a person passing through gate 400, and detection camera 501 that detects tailgating and the like. Gate 400 in an arc-like shape illustrated in FIG. 13 also includes two cameras respectively for a long distance, a mid distance, and a short distance. Camera 1-1A and camera 1-1B are the two long-distance cameras and disposed respectively on left and right pole portions of a housing of gate 400. Camera 1-2A and camera 1-2B are the two mid-distance cameras and disposed respectively on the left and right pole portions of the housing of gate 400. Camera 1-3A and camera 1-3B are the two short-distance cameras and disposed respectively on the left and right pole portions of the housing of gate 400. By disposing one camera each for capturing each distance on the left and right sides, even when the face of the person passing through the gate is oriented to either the left or right side, either of these cameras can take an image of the frontal face suitable for the verification.

Note that, one each of the long-distance camera, the mid-distance camera, and the short-distance camera are all disposed on both the left and right sides in FIG. 13; however, one each of the cameras are not required to be disposed on both the left and right sides for every distance. For example, in an environment and the like where the orientation of the people's faces are expected to have a certain level of tendency, the camera on the side opposite to that orientation has merely an auxiliary role, and not required to be disposed for all of the long distance, the mid distance, and the short distance. Other examples for omitting the camera on either the left or right side for any of the distances may include a circumstance hindering mounting of the camera on either the left or right side, such as the shape of the gate, the internal structure of the gate, the design constraints, and the like. Note that, since with a greater distance the image-taking result is less likely influenced by the difference of the face orientation, omission of the camera for the greater distance may contribute to minimizing the influence when any one camera on either the left or right side is to be omitted.

By thus disposing the plurality of cameras for each of the long distance, the mid distance, and the short distance, the facial image capturing the frontal face is more likely to be obtained even in the case in which the face of a person passing through gate 400 is oriented in a direction different from the traveling direction. Note that the shape of gate 400, the positions of the cameras, and the number of the cameras are not limited to the above-described embodiment.

Note that, an example of carrying out the narrowing down search process twice has been described in the above-described embodiment; however, a configuration of carrying out the narrowing down search process once (the long-distance narrowing down search process or the mid-distance narrowing down search process) may also be contemplated.

According to this configuration example, since the narrowing down search process is carried out once, the processing time of the narrowing down can be reduced and the number of the cameras for taking images used for the narrowing down search process can be reduced. Consequently, the system configuration is simplified, whereby speeding-up of the face authentication process is enabled with reduction of cost involved in system construction.

In addition, according to this configuration example, since the narrowing down search process is carried out in face authentication server 200, a massive amount of verification information that cannot be stored in verification apparatus 21 can be processed. Furthermore, since face authentication server 200 can be shared between gates 400 configured in a plurality of sites, speeding-up of the face authentication process and effective use of the resource are enabled.

Note that, in this configuration example, the narrowing down search is carried out once in face authentication server 200; however, a configuration of carrying out the second narrowing down search process in verification apparatus 21 after the narrowing down search in face authentication server 200 may also be contemplated. In this case, processor 102 of verification apparatus 21 uses a third facial image taken by the mid-distance camera for capturing the faces of people present in area A2 between area A1 and area A3, to further narrow down the facial images obtained from face authentication server 200 to the facial images of people who may pass through gate 400. Processor 102 of verification apparatus 21 verifies the second facial image against the facial images thus narrowed down. For example, in the case in which verification candidate list ML is great in size, transmission from face authentication server 200 to verification apparatus 21 may take time, and the narrowing down search process using verification candidate list ML may take time due to the performance of verification apparatus 21. In such a case, the above-described configuration enables further speeding-up of the face authentication process. Note that, in a case in which verification candidate list ML is sufficiently small in size, the configuration in which face authentication server 200 transmits verification candidate list ML to verification apparatus 21 at an early stage and verification apparatus 21 carries out the second narrowing down, as in the above-described configuration example, may speed up the process. In this regard, the second narrowing down search process may be switched between being performed by face authentication server 200 and being performed by verification apparatus 21, according to the size of verification candidate list ML.

Hereafter, modifications of the narrowing down search process, the face authentication process, and the like in face authentication server 200 and verification apparatus 21 are described.

Note that, in the long-distance narrowing down search (primary narrowing down search) in FIG. 5 described above, an example in which face authentication server 200 buffers a predetermined number (for example, N₁) of facial images in the descending order of the score calculated for each of the facial images included in face registration DB 203 to verification candidate list ML has been described; however, the present disclosure is not limited thereto. For example, face authentication server 200 may buffer the facial images corresponding to scores greater than a first threshold value among the scores calculated for the respective facial images included in face registration DB 203 to verification candidate list ML.

In addition, in the long-distance narrowing down search (primary narrowing down search) in FIG. 5 described above, an example in which verification apparatus 21 buffers a predetermined number (for example, N₂) of facial images in the descending order of the scores calculated for the respective facial images included in verification candidate list ML to verification candidate list SL has been described.

According to this configuration example, the upper limit can be defined for the number of facial images to be buffered to verification candidate list SL, whereby buffer overflow can be prevented even in a case in which a large number of high-score facial images are found.

However, the present disclosure is not limited thereto. For example, verification apparatus 21 may buffer the facial images corresponding to scores greater than a second threshold value greater than the first threshold value among the scores calculated for each of the facial images included in verification candidate list ML to verification candidate list SL.

According to this configuration example, since the narrowing down search process based on the threshold value is carried out, the facial images corresponding to scores greater than the threshold value are not excluded from the verification candidate and the facial images corresponding to scores lower than the threshold value are excluded from the verification candidate, whereby speeding-up and increase in accuracy of the face authentication process are enabled.

Note that, although the secondary narrowing down search is carried out in this configuration example, the secondary narrowing down search may be omitted. An example of such a case is described below.

In a case in which carrying out the secondary narrowing down search is not necessary as a result of the primary narrowing down search, processor 102 may carry out the face authentication process without carrying out the secondary narrowing down search. The case in which the secondary narrowing down search is not necessary may refer to, for example, a case in which the number of the facial images corresponding to the scores lower than the threshold value as a result of the primary narrowing down search is the number not requiring the secondary narrowing down search (for example, 1). Alternatively, the case in which the secondary narrowing down search is not necessary may also refer to a case in which a difference between the highest score and the N-th highest score (N being an integer of 2 or greater) as a result of the primary narrowing down search is greater than or equal to a predetermined difference.

According to this example, the secondary narrowing down search can be omitted, whereby reduction of the processing time of the narrowing down and in turn speeding-up of the face authentication process is enabled.

Note that, in a case in which the primary narrowing down search and the secondary narrowing down search give a sufficiently accurate verification result, the face authentication process may be omitted. An example of such a case is described below.

The case in which the primary narrowing down search and the secondary narrowing down search give a sufficiently accurate verification result may refer to, for example, a case in which a difference between the highest score and the second highest score as a result of the secondary narrowing down search is greater than or equal to a predetermined difference. In this case, processor 102 may generate the result of the secondary narrowing down search as result information R indicating successful authentication, without carrying out the face authentication process.

According to this example, the face authentication process may be omitted, whereby reduction of the processing time of the face authentication process is enabled.

Note that, in a case in which the scores are too low for all face candidates included in the secondary narrowing down result, the facial image taken by the mid-distance camera may be transmitted to face authentication server 200 and candidates to be buffered may be re-obtained. A configuration example of such a case is described below.

As a result of the secondary narrowing down, in a case in which the facial image corresponding to the score greater than the second threshold value can be verified against the third facial image, processor 102 of verification apparatus 21 carries out the face authentication process without transmitting a plurality of third facial images to face authentication server 200.

As a result of the secondary narrowing down, in a case in which the facial image corresponding to the score greater than the second threshold value cannot be verified against the third facial image, processor 102 of verification apparatus 21 transmits a plurality of third facial images to face authentication server 200 and causes face authentication server 200 to carry out narrowing down of the facial images from the plurality of third facial images. Processor 102 of verification apparatus 21 obtains the facial image thus narrowed down from face authentication server 200, and narrows down again the facial images obtained from face authentication server 200 to the facial images of people who may pass through gate 400.

According to this configuration example, the facial image taken by the mid-distance camera can be transmitted to face authentication server 200, and candidates to be buffered can be re-obtained. Consequently, even in the case in which the scores are too low for all face candidates included in the secondary narrowing down result, a certain level or more of accuracy of the narrowing down can be ensured, whereby speeding-up of the face authentication process is enabled, with suppression of reduction of accuracy of the face authentication process.

Note that processor 102 may also be configured to, for example, obtain a feature amount indicating a feature of the face included in the facial image taken by the long-distance camera, the mid-distance camera, or the short-distance camera, and narrow down the plurality of pieces of verification information to the facial images of people who may pass through gate 400 by using the feature amount. Alternatively, processor 102 may also be configured to obtain a feature amount indicating a feature of the face included in the facial image narrowed down by face authentication server 200, and narrow down the plurality of pieces of verification information to the facial images of people who may pass through gate 400 by using the feature amount. Here, the feature amount may be exemplified by the color, shape, brightness distribution and the like of the face. The feature amount may also be generated by a more complex process employed in the field of machine learning. By using the feature amount, size of information exchanged between face authentication server 200 and verification apparatus 21 may be suppressed. In addition, depending on the feature amount used, influence of parameters that are likely to change in the real environment is suppressed, whereby robust face authentication is enabled.

Note that, in the above-described embodiment, an example in which the authentication information is recorded in face authentication server 200 has been described; however, the present disclosure is not limited thereto. For example, the authentication information may also be recorded in verification apparatus 21 or gate control apparatus 20. For example, in a case in which verification apparatus 21 has a large recording volume allowing recording of a large amount of information of facial images (authentication information) as well as processing performance allowing the primary narrowing down search process to be carried out, processor 102 of verification apparatus 21 may narrow down the plurality of pieces of verification information to the facial image by using the first facial image.

In face authentication system 100, the number of the plurality of cameras 1 may be 4 or greater. The number of times of the narrowing down may be, for example, 3 or greater. Specifically, in this configuration, four or more cameras take images of four or more areas respectively. The greater number of times of the narrowing down allows processing of facial images of a greater number of people (for example, in a case in which a greater number of facial images are stored in face registration DB 203). A greater number of times of the narrowing down may lead to an increase in time required for re-search in the case of determination failure, and consequently, the threshold value of the scores may be lowered as the number of times increases.

Face authentication server 200 may also carry out the second narrowing down search process. Particularly in the case in which verification candidate list ML is great in size, the configuration in which verification candidate list ML is transmitted to verification apparatus 21 and the second narrowing down search process is carried out locally may take more time, depending on performance of network 300 and verification apparatus 21. The second narrowing down search process may be configured to be switchable between being carried out by face authentication server 200 or not, on the basis of the size of verification candidate list ML, communication rate of network 300, the buffer size of verification apparatus 21, or processing performance of verification apparatus 21. In the case of adding candidates with scores greater than or equal to the threshold value to verification candidate list ML, verification candidate list ML has a variable size and performing such switching is beneficial.

Also in the case in which three or more narrowing search processes are carried out, the number of narrowing search process(es) to be carried out by face authentication server 200 may be determined from a similar viewpoint.

The short-distance camera, the mid-distance camera, and the long-distance camera are not required to be provided in each of plurality of gates 400 and, for example, the mid-distance camera and the long-distance camera may be shared between plurality of gates 400.

In the above-described embodiment, the information used in each narrowing down, and the information used for obtaining the authentication result may be different from one another. For example, a feature amount of contours of the face may be used for the narrowing down, and a feature amount of parts of the face may be used for obtaining the authentication result. Since the size of the facial image taken is different between the long-distance camera and the short-distance camera, using information appropriate for each distance enables further improvement of accuracy of the determination. Simply in the sense of comprehensively evaluating from the plurality of viewpoints, improvement of accuracy can be expected by carrying out the narrowing down and the process of obtaining the authentication result by using different types of information.

On the other hand, the information used in each narrowing down, and the information used for obtaining the authentication result may also be the same in type. In this case, the evaluation is made from the same viewpoint in the previous narrowing down and the current narrowing down or the face authentication process, whereby suppression of an occurrence of inconsistency in determination result is enabled. As a result, frequency of generation of the request to face authentication server 200 due to a failure in the face authentication can be reduced, whereby speeding-up of the face authentication process can be expected.

In the above-described embodiment, the facial image included in the verification candidate list obtained as a result of the narrowing down is not limited to the very image and may also be a feature amount thereof (this information is also referred to as “candidate facial image”). Particularly in regard to the verification candidate list transmitted from face authentication server 200 to verification apparatus 21, a list consisting of the feature amounts enables further reduction of communication traffic. However, since it is typically difficult to carry out verification of the information obtained by extracting the feature amount with another type of feature amount, in a case of carrying out the verification with a different type of feature amount in each step, the verification candidate list is preferably composed of the very facial images, despite an increase in size of the verification candidate list. Also in a circumstance in which the size of the verification candidate list is not likely to affect the communication traffic, such as the case in which a plurality of cycles of narrowing down are carried out in face authentication server 200, the verification candidate list may be constituted of the very facial images and the feature amount may be extracted upon creation of the verification candidate list to be transmitted to verification apparatus 21.

In the above-described embodiment, gate 400 is provided with opening/closing door mechanism 4; however, a section (regulator) for regulating movement of the person in the case of a failure in the face verification is not limited thereto. For example, a psychologically regulating mechanism such as a siren and/or an alarm may be employed. Alternatively, a mechanism of indirectly regulating movement by notifying a guard and/or a robot and the like disposed in the vicinity, without notifying the very person about to pass through the gate may be employed. Note that a time period between a failure in the face verification and execution of regulation varies depending on the type of the regulator to be employed; however, regardless of the type of the section, it is same that speeding-up of the face verification is beneficial for obtaining the result of the face verification before the person reaches the regulator.

Stated another way, a section (regulator) for regulating movement of the person in the case of a failure in the face verification is not limited to an example of physically regulating (blocking) movement of the person, such as opening/closing door mechanism 4 provided in the middle of a movement path of the person in gate 400. For example, with a predetermined point (or a predetermined area) being set in gate 400, gate 400 may regulate movement of the person from an upstream side of the predetermined point to a downstream side of the predetermined point in the movement direction of the person. In this case, the regulating section may be a siren and/or an alarm and the like, or notification to a guard and/or a robot and the like, as described above. In this case, the image-taking range of each of the cameras may be positioned upstream of the predetermined point. For example, in the order from closest to the predetermined point, the image-taking range of the short-distance camera (for example area A3 in FIG. 4), the image-taking range of the mid-distance camera (for example area A2 in FIG. 4), and the image-taking range of the long-distance camera (for example area A1 in FIG. 4) may be provided.

In the above-described embodiment, verification apparatus 21 has been described as an apparatus used in a gate regulating movement of a person; however, verification apparatus 21 is not limited thereto. Verification apparatus 21 can be applied to any system carrying out the face authentication of a person approaching from a long distance. In this case, definition of area A3 (see FIG. 4) in which the face authentication process is carried out in the above-described embodiment is different depending on requirements of the system. For example, in a case of application to a surveillance system and the like employing a surveillance camera that records a person having passed through a predetermined surveillance point, the vicinity of the surveillance point (for example, a range upstream of the surveillance point) and the like may be defined as area A3.

As described in the foregoing, verification apparatus 21 verifies the verification candidates narrowed down by using the first facial image taken by the first camera that captures area A1 against the second facial image taken by the second camera that captures area A3 into which the person may move from area A1.

Such a configuration enables, with the facial image of a person approaching gate 400 being captured, the narrowing down search in the verification information with a large population to be carried out by using the facial image before the person enters gate 400. The face verification process using the mid-distance camera or the short-distance camera can thus be sped up.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

In addition, in recent years, in Internet of Things (IoT) technology, Cyber Physical Systems (CPS), which is a new concept of creating new added value by information collaboration between physical space and cyberspace, has been attracting attention. Also in the above embodiments, this CPS concept can be adopted.

That is, as a basic configuration of the CPS, for example, an edge server disposed in the physical space and a cloud server disposed in the cyberspace can be connected via a network, and processing can be distributedly performed by processors mounted on both of the servers. Here, it is preferable that processed data generated in the edge server or the cloud server be generated on a standardized platform, and by using such a standardized platform, it is possible to improve efficiency in building a system including various sensor groups and/or IoT application software.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Moreover, any combination of features of the above-mentioned embodiments may be made without departing from the spirit of the disclosure.

While concrete examples of the present invention have been described in detail above, those examples are mere examples and do not limit the scope of the appended claims. The techniques disclosed in the scope of the appended claims include various modifications and variations of the concrete examples exemplified above.

All disclosures in the specification, the drawings, and the abstract of Japanese Patent Application No. 2020-025246, filed on Feb. 18, 2020 are incorporated in the present application.

### INDUSTRIAL APPLICABILITY

Example of the present disclosure is suitable for an apparatus or a system that carries out verification (or authentication) by a facial image.

### REFERENCE SIGNS LIST

1, 1-1, 1-2, 1-3 Camera
2 QR code reader
3 Passing management photoelectronic sensor
4 Opening/closing door mechanism
5 Entrance guidance indicator
6 Passing guidance LED
7 Guidance display
8 Speaker
9 Interface board
10 Interface driver
20 Gate control apparatus
21 Verification apparatus
30 Network hub
100 Face authentication system
101, 202 Communicator
102, 201 Processor
103 Buffer
200 Face authentication server
203 Face registration DB
300 Network
400 Gate
500 Reader
501 Detection camera
601, 701 Processor
602, 702 Memory
603, 703 Input/output interface
604, 704 Bus

1. A verification apparatus used in a gate provided with a regulator that regulates a stream of people, the verification apparatus comprising:
a processor that carries out, in a path with a stream of people from a first area to a second area located upstream of the regulator, second facial image verification by using a first candidate facial image narrowed down by a result of first facial image verification using a first image taken of the first area, and a second image taken of the second area; and
a communicator that outputs a result of the second facial image verification.

2. The verification apparatus according to claim 1, wherein
the gate comprises a sensor that detects entry of a person to the gate, and
the second area is located in the stream of people, at or downstream of a position where the entry of a person is detected and upstream of the regulator.

3. The verification apparatus according to claim 1, wherein the processor narrows down the first candidate facial image by using a third image taken of a third area between the first area and the second area, and verifies a second candidate facial image, which is obtained by the narrowing down, against the second image.

4. The verification apparatus according to claim 3, wherein:
the communicator obtains the first candidate facial image from a server provided outside the verification apparatus, and
the verification apparatus obtains the second candidate facial image by narrowing down the first candidate facial image in the verification apparatus.

5. The verification apparatus according to claim 3, wherein:
the processor determines a score indicating similarity of two facial images between each of N₁ first candidate facial images (N₁ being an integer of 2 or greater) and the third image, and
the processor determines the second candidate facial image obtained by narrowing down the first candidate facial images to candidates corresponding to top N₂ scores among the N₁ scores (N₂ being an integer of 1 or greater and less than N₁).

6. The verification apparatus according to claim 3, wherein:
the processor determines a score indicating similarity of two facial images between each of a plurality of the first candidate facial images and the third image,
the processor determines the second candidate facial image obtained by narrowing down the first candidate facial image to a candidate having the score greater than or equal to a second threshold value,
the first candidate facial image has the score with the first image greater than or equal to a first threshold value, and
the first threshold value is smaller than the second threshold value.

7. The verification apparatus according to claim 6, wherein the processor does not determine the second candidate facial image when a number of the plurality of first candidate facial images is less than a third threshold value.

8. The verification apparatus according to claim 6, wherein the processor does not carry out verification against the second image when a number of one or a plurality of the second candidate facial images is less than a fourth threshold value.

9. The verification apparatus according to claim 6, wherein the processor requests a server provided outside the verification apparatus to determine the second candidate facial image when each of a plurality of the scores between each of the plurality of first candidate facial images and the third image is less than a fifth threshold value.

10. The verification apparatus according to claim 1, wherein the processor requests a server provided outside the verification apparatus to carry out verification related to the second image when verification against the second image has failed.

11. A verification system used in a gate provided with a regulator that regulates a stream of people, the verification system comprising:
a first camera that takes an image of a first area in a stream of people from the first area to a second area located upstream of the regulator;
a second camera that takes an image of the second area;
a first verification apparatus that carries out first facial image verification using a first image taken by the first camera; and
a second verification apparatus that carries out second facial image verification using a first candidate facial image narrowed down by a result of the first facial image verification and the second image taken by the second camera.

12. The verification system according to claim 11, wherein the first camera and the second camera are installed in the gate or in an installation site of the gate.

13. The verification system according to claim 12, wherein:
the first verification apparatus is provided on the server,
the second verification apparatus is provided in the gate, and
the second verification apparatus receives the first candidate facial image from the server.

14. The verification system according to claim 12 comprising a control apparatus that controls the gate on based on a result of the second facial image verification input from the second verification apparatus.

15. A verification method used in a gate provided with a regulator that regulates a stream of people, the verification method comprising:
carrying out, in a path with a stream of people from a first area to a second area located upstream of the regulator, second facial image verification by using a first candidate facial image narrowed down by a result of first facial image verification using a first image taken of the first area, and a second image taken of the second area; and
outputting a result of the second facial image verification.
